(19) United States
(12) Patent Application Publication
(10) Pub. No.: US 2020/0102029 A1
(43) Pub. Date: Apr. 2, 2020

(54) Trailer Vehicle Apparatuses

(71) Applicant: Timothy Donald Blevins, DeKalb, TX (US)

(72) Inventor: Timothy Donald Blevins, DeKalb, TX (US)

(21) Appl. No.: 16/586,769

(22) Filed: Sep. 27, 2019

Related U.S. Application Data
(60) Provisional application No. 62/737,460, filed on Sep. 27, 2018.

(51) Int. Cl. B62D 63/06; B62D 63/08; B60B 35/04; B60B 35/00; B60S 9/02

(52) U.S. Cl. CPC B62D 63/062; B62D 63/08; B60D 1/48; B60B 35/004; B60S 9/02; B60B 35/04

(57) ABSTRACT

The present invention is directed to a trailer vehicle apparatus comprising a trailer body, an axle, and a truss suspension structure (“TSS”). The axle comprises a shaft traversing the trailer body width. TSS comprises first and second platforms and truss structures. The first and second platforms comprising a first and second proximate end, respectively. Each truss structure is: perpendicularly oriented relative to the top surface of the platforms; affixed to corner nodes of the first and second proximate ends; and comprises a strut channel perpendicularly oriented relative to the top surfaces of the platforms as well as traverses a length of the truss structure. TSS is affixed to a bottom surface of the trailer body. The axle shaft comprises strut structures each slidably mounted within a strut channel. Strut structures are configured to traverse the strut channel as the trailer vehicle converts between a mobile state and a stationary state.

### CROSS-REFERENCE TO RELATED APPLICATIONS

This application claims priority to U.S. Provisional Application No. 62/737,460 filed Sep. 27, 2018, which is hereby incorporated herein by reference.

### FIELD OF THE INVENTION

The present invention relates generally to trailer vehicle apparatuses and specifically to trailer vehicles apparatuses having suspension trusses.

### BACKGROUND OF THE INVENTION

Trailers are unpowered vehicles that may be towed by another vehicle (e.g., a powered vehicle). Presently, people typically utilize trailers for transporting a wide variety of objects. To load or unload such trailers, trailer may have to be raised or lowered using trailer jacks or similar apparatus that may be utilized to raise or lower trailers. However, on their own, trailer jacks can be difficult to operate, for example, it may be difficult to control the rate of elevation and/or declination of all trailer jacks at the same time. Similarly, trailer jacks are typically incapable of lowering the floor of the trailer onto the ground without reducing the storage space of the trailer as a compromise to make room for the wheels and/or axles of the trailer.

### BRIEF DESCRIPTION OF THE DRAWINGS

Unless otherwise specifically noted, articles depicted in the drawings are not necessarily drawn to scale. Other technical advantages may become readily apparent to one of ordinary skill in the art after review of the following figures and description. Some of the embodiments will be described in detail, with reference to the following figures, wherein like designations denote like members, wherein:

FIG. 1 is a front perspective view of a truss suspension structure according some embodiments.

FIG. 2 is a side view of the truss suspension structure according to some embodiments.

FIG. 3 is a front perspective view of the truss suspension structure according to some embodiments.

FIG. 4 is a top perspective view of an axle according to some embodiments.

FIG. 5 is a bottom perspective view of the axle according to some embodiments.

FIG. 6 is a side view of a trailer vehicle in its “stationary” state according to some embodiments.

FIG. 7 is a side view of the trailer vehicle in its “mobile” state according to some embodiments.

FIG. 8 is a close-up side view of the truss suspension system according to some embodiments.

Unless otherwise specifically noted, articles depicted in the drawings are not necessarily drawn to scale.

### DETAIL DESCRIPTIONS OF THE INVENTION

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Modifications, additions, or omissions may be made to the apparatuses described herein without departing from the scope of the disclosure. For example, the components of the apparatuses may be integrated or separated. Moreover, the operations of the apparatuses disclosed herein may be performed by more, fewer, or other components. As used in this document, “each” refers to each member of a set or each member of a subset of a set.

All illustrations of the drawings are to be interpreted as describing selected versions of the present invention and are not intended to limit the scope of the present invention. All references of user or users pertain to either individual or individuals who would utilize one or more embodiments disclosed herein. All references of trailer(s) can pertain to trailers, gooseneck trailers, horse trailers, and/or other similar apparatuses.

Trailers are unpowered vehicles that may be towed by another vehicle (e.g., a powered or unpowered vehicle). Presently, people typically utilize trailers for transporting a wide variety of objects. To load or unload such trailers, trailer may have to be raised or lowered using trailer jacks or similar apparatus that may be utilized to raise or lower trailers. However, on their own, trailer jacks can be difficult to operate, for example, it may be difficult to control the rate of elevation and/or declination of all trailer jacks at the same time. Similarly, trailer jacks are typically incapable of lowering the floor of the trailer onto the ground without reducing the storage space of the trailer as a compromise to make room for the wheels and/or axles of the trailer.

An objective of the present invention is to provide users with a trailer vehicle apparatus. The present invention intends to provide users with an apparatus that can raise the axles and/or wheels of a trailer or similar object in order to lower the floor of the trailer or similar object to be touching the ground. The present invention intends to provide users with a device that can raise the floor of a trailer or similar object off of the ground in order to lower the axles and/or wheels of the trailer or similar object. Embodiments disclosed herein intend to provide users with a locking mechanism for the trailer vehicle apparatus to maintain and support the floor of the trailer vehicle apparatus above the ground that is simple and easy to utilize for the user.

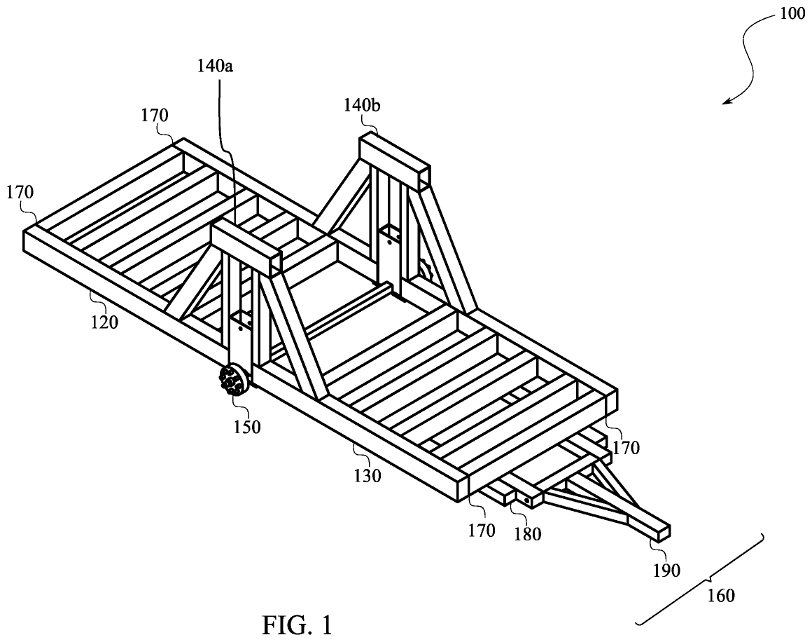

Embodiments conveyed herein seek to disclose trailer vehicle apparatuses (“trailer vehicle”). Trailers vehicles are typically unpowered vehicles that may be towed by another vehicle (e.g., cars, trucks, or other vehicles) and used to transport objects. FIG. 1 is a front perspective view of a truss suspension structure, generally 100, according some embodiments. FIG. 1 depicts a perspective view of truss suspension structure (“TSS”) 100. In certain embodiments, the TSS 100 comprises a trailer body 610 (discussed below). For example, trailer body 610 can comprise at least four walls and a ceiling interconnected together. In other embodiments, axle 150 traverses the width of the trailer body of TSS 100. Some aspects of TSS 100 include platform 120, platform 130 connected via at least two truss structure 140. In some embodiments, platforms 120 and 130 are each formed using tubular beams (e.g., 2×6 rectangular steel tubes and 2×4 rectangular steel tubes). For example, tubular steel beams are utilized to reduce the overall weight/mass of TSS 100. Two or more components disclosed herein may be welded together.

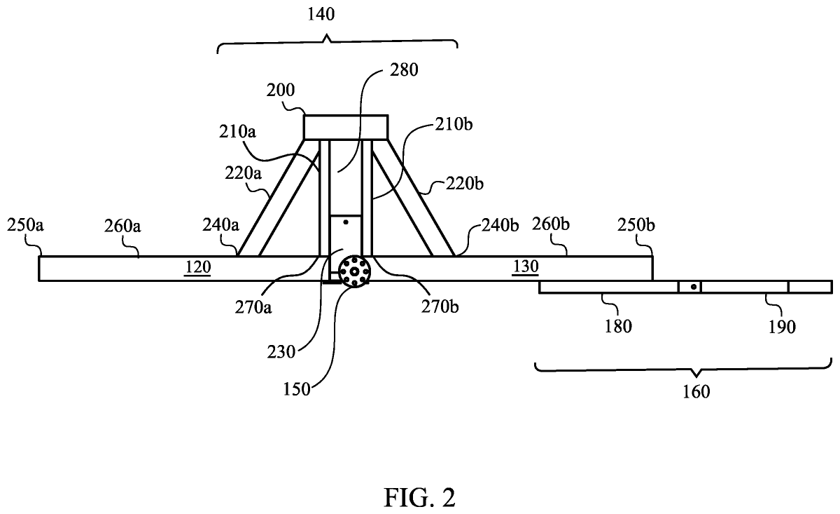

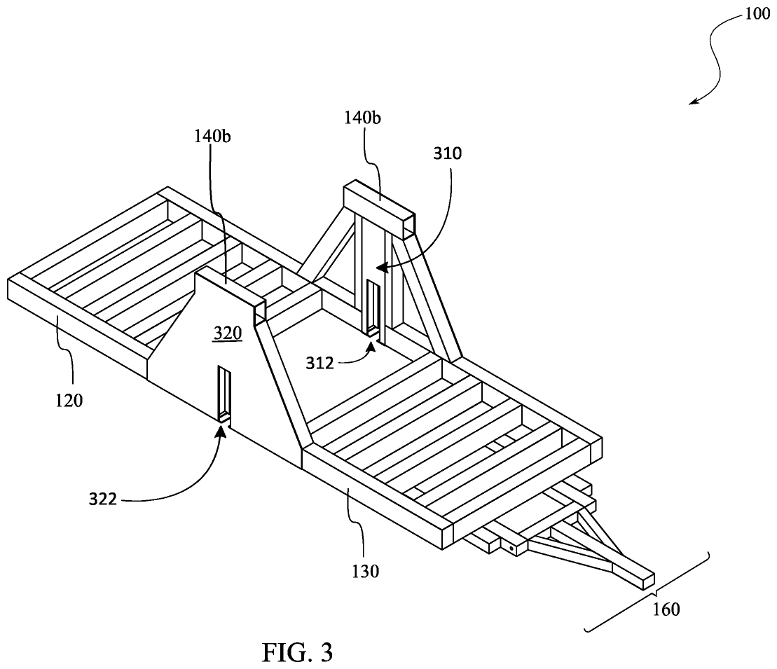

For example, the frame of platforms 120 and 130 are formed using 2×6 rectangular steel tubes, wherein the 2×4 rectangular steel tube are utilized as support beams affixed to and reinforcing the frame. FIGS. 2 and 3 illustrate a side view and a front perspective view, respectively, of TSS 100 according to some embodiments. Some aspects of platform 120 include proximate end 240a and distal end 250a. Certain aspects of platform 130 can include proximate end 240b and distal end 250b.

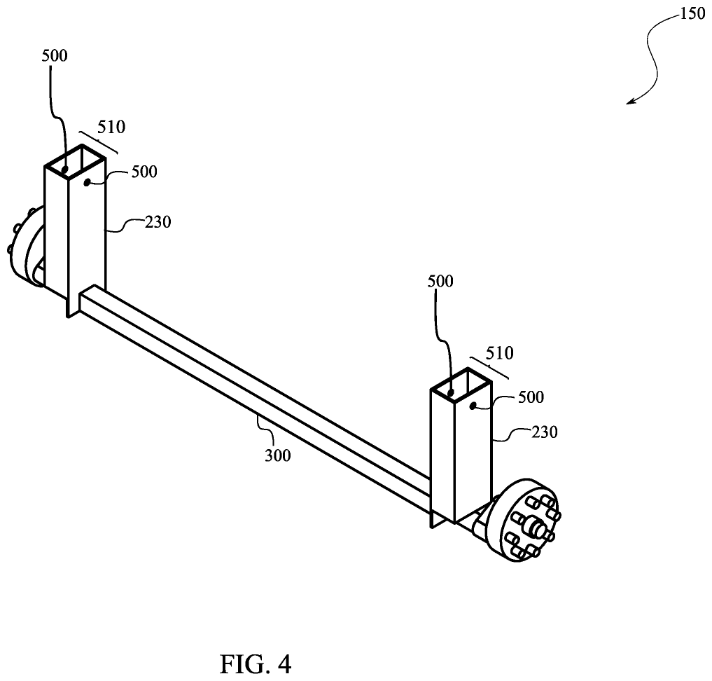

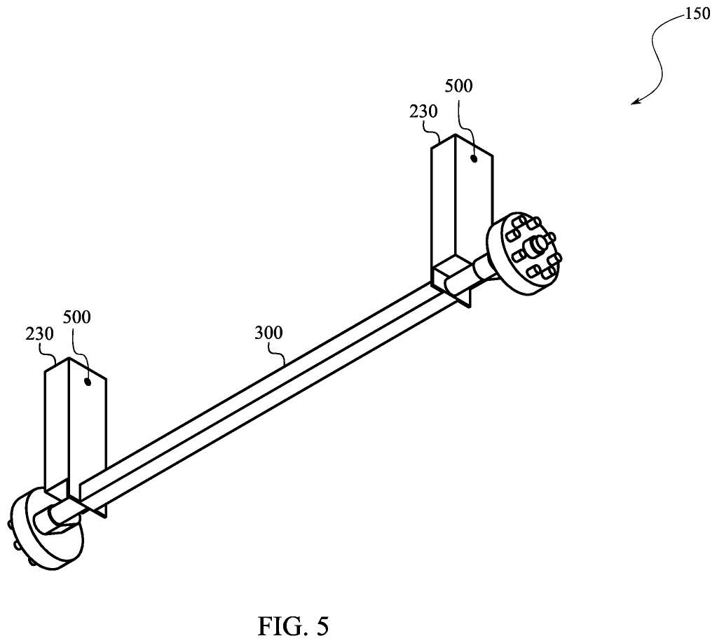

In certain embodiments, each truss structure 140 is perpendicularly oriented relative to both surface 260a of platform 120 and surface 260b of platform 130. For example, each truss structure 140 includes strut channel 280 co-planarly positioned therein. Some aspects of truss structure 140 include strut channel 280 perpendicularly oriented relative to both top surface 260 of platform 120 and top surface 260b of second platform 130. As used herein, a “top surface” refers to a surface oriented away from surface 680 (discussed below). For example, strut channel 280 traverses a length of truss structure 140. In other embodiments, TSS 100 is affixed proximate to the bottom surface (i.e. the surface configured to be oriented toward the ground surface) of trailer body 610. FIGS. 4 and 5 illustrate a top perspective view and a bottom perspective view, respectively, of axle 150 according to some embodiments. Certain aspects of axle shaft 300 include strut structures 510 each slidably mounted within a struct channel 280.

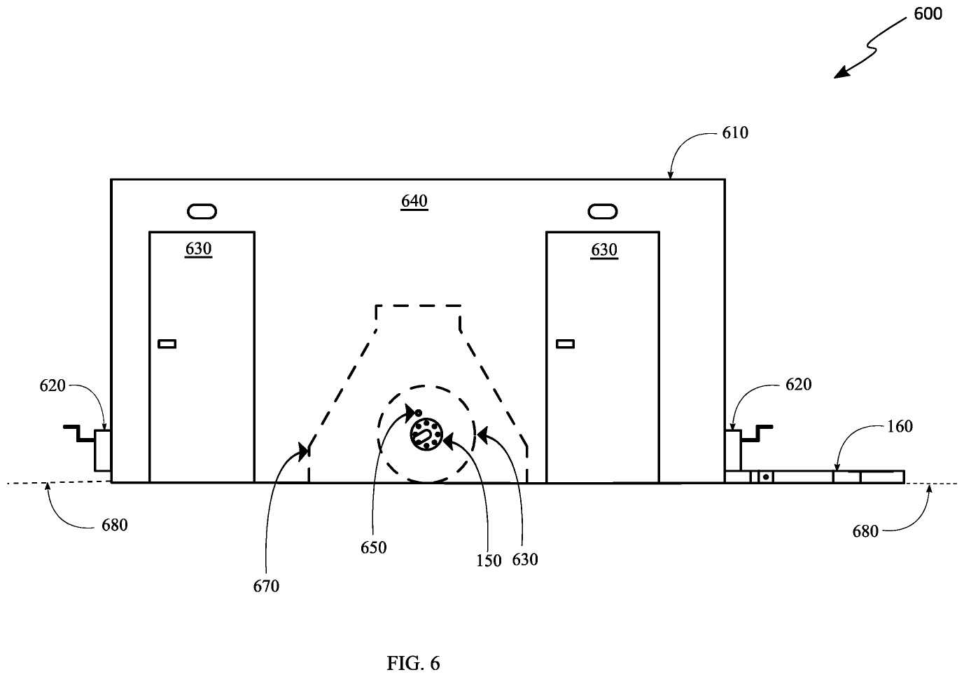

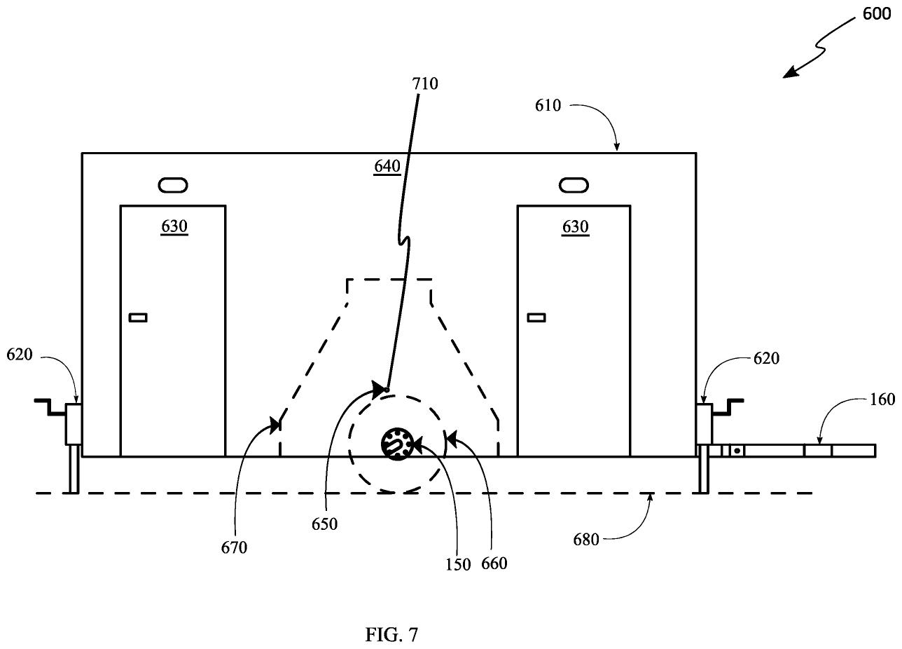

FIGS. 6 and 7 illustrate side views of trailer vehicle 600 in its “stationary” and “mobile” states, respectively, according to some embodiments. In other aspects, strut structures 230 are configured to traverse strut channel 280 as trailer vehicle 600 converts between its “mobile” and “stationary” states. During operation, trailer vehicle 600 rests and travels on surface 680 (e.g., road, street, highway, ect.). For example, in the “mobile” state, strut structure 230 rests flush with braces 810, which restricts strut structures ability to substantially extend beyond platforms 120 and 130. in the “mobile” state, strut structures 230, and thereby axle 150, extend away from TSS 100, which provides clearance beneath trailer vehicle 600. Some aspects of truss structure 140 includes panel 320 and panel 310. In some embodiments, panel 320 is oriented on the external portion (i.e. the portion of truss structure 140 oriented away from TSS 100) of truss structure 140. For example, panel 320 includes slot 322, which traverses strut channel 280. In other embodiments, panel 310 is oriented on the internal portion (e.g. the portion of truss structure 140 oriented towards the other truss structure 140) of truss structure 140. For example, panel 310 includes slot 312, which traverses strut channel 280. Certain aspects of slots 312 and 322 have a width that accommodates axle 150.

In yet still other embodiments, each truss structure 140 includes vertical beams 210. For example, vertical beams 210 each include an end affixed to support beam 200 and another end affixed to proximate to corner node 270a of proximate end 240a (e.g., vertical beam 210a) or corner node 270b of proximate end 240b (e.g., vertical beam 210b). In some aspects, vertical beams 210 are each perpendicularly oriented relative to support beam 200, platform 120, and platform 130. In other aspects, the distance between vertical beams 210 form strut channel 280.

In other embodiments, each truss structure 140 includes buttress beams 220 (e.g., diagonally positioned support structures). For example, buttress beams 220 each include an end affixed to platform 120 proximate to proximate end 240 and another end affixed to and forming a joint with support beam 200 and vertical beam 210. Buttress beams 220 are obliquely positioned relative to support beam 200 as well as platforms 120 and 130. In some embodiments, trailer vehicle 600 includes trailer jacks 620 each positioned proximate to a corner node 170 of distal ends 250. For example, trailer jacks 620 are typical trailer jacks configured to raise and lower trailer vehicle 600 (e.g., by cranking trailer jack 620 in one or more predetermined directions) as well as support a portion of the mass of trailer vehicle 600 when stationary. In other embodiments, trailer jacks 620 are affixed to TSS 100 (e.g., proximate to corner nodes 170). In still other embodiments, each truss structures 140 is positioned within the walls of trailer body 610.

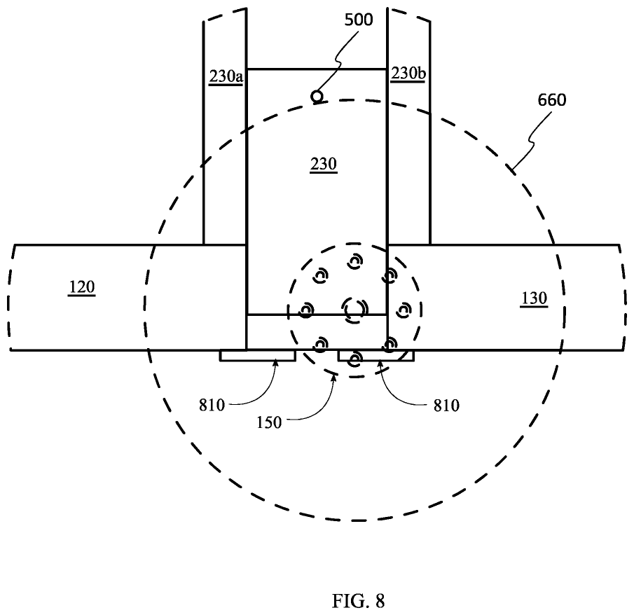

Some aspects of each strut structure 230 include pin orifices 500 traversing two of the walls of strut structure 230. In some embodiments, wall 640 of trailer body 610 includes pin orifice 650 traversing therethrough, where pin fastener 710 (e.g., an elongated fastener) is positioned through pin orifices 640 and pin orifice 500 and thereby lock axle 150 in position when trailer vehicle 600 is in its mobile state. As discussed above, in the “mobile” state, strut structure 230 rests flush with braces 810. For example, one or more braces 810 can be metal (e.g., steel or other metals of similar physical characteristics) plate bolted on to platforms 120 and 130 adjacent to the bottom (i.e. the surface proximate to surface 680) of strut channel 280 as reflected in FIG. 8. Certain aspects of TSS 100 include hitch component 160. Other aspects of TSS 100 include hitch base 180 and hitch coupler 190. For example, hitch base 180 is affixed to a bottom surface of platform 130 (e.g., proximate to distal end 250b). In some embodiments, hitch coupler 190 is rotatably mounted to hitch base 180. Typically, hitch coupler 190 is configured to demountably attach to the receiver hitch of a powered vehicle.

Although the invention has been explained in relation to its preferred embodiment, it is to be understood that many other possible modifications and variations can be made without departing from the spirit and scope of the invention. To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A trailer vehicle apparatus comprising:
a trailer body;
an axle comprising a shaft traversing a width of the trailer body;
a truss suspension structure comprising:
a first platform comprising a first proximate end;
a second platform comprising a second proximate end;
a plurality of truss structures each
perpendicularly oriented relative to both a top surface of the first platform and a top surface of the second platform
are affixed to a corner node of the first proximate end and a corner node of the second proximate end;
comprise a strut channel perpendicularly oriented relative to both a top surface of the first platform and a top surface of the second platform and traversing a length of the truss structure;
wherein
the truss suspension structure is affixed to a bottom surface of the trailer body;
the axle shaft comprises a plurality of strut structures each slidably mounted within the struct channel of one of the truss structures; and
the plurality of strut structures configured to traverse the strut channel as the trailer vehicle converts between a mobile state and a stationary state.

2. The trailer vehicle apparatus of claim 1, wherein each of the truss structures further comprises:
a first vertical beam, a second vertical beam;
wherein
the first vertical beam and the second vertical beam each comprise:
a first end affixed to a support beam;
a second end;
a perpendicular orientation relative to the support beam, the first platform, and the second platform;
the second end of the first vertical beam is affixed proximate to a corner node of the first proximate end; and
the second end of the second vertical beam is affixed proximate to a corner node of the second proximate end, respectively.

3. The trailer vehicle apparatus of claim 2, wherein each of the truss structures further comprising
a first buttress beam, and a second buttress beam;
wherein
the first buttress beam and the second buttress beam each comprise:
a first buttress end;
a second buttress end positioned opposite to the first buttress end;
the first buttress end of the first buttress beam is affixed proximate to the first proximate end;
the first buttress end of the second buttress beam is affixed proximate to the second proximate end;
the second buttress end of the first buttress beam is affixed to and forms a joint with the support beam and the first vertical beam; and
the second buttress end of the second buttress beam is affixed to and forms a joint with the support beam and the second vertical beam.

4. The trailer vehicle apparatus of claim 3. further comprising:
a plurality of trailer jacks;
wherein
the first platform and the second platform each comprise a distal end positioned distal to the plurality of truss structures;
the distal end of the first platform comprise first distal corner nodes;
the distal end of the second platform comprise second distal corner nodes;
wherein the plurality of trailer jacks are each
configured to support a mass of the trailer vehicle when the trailer vehicle is stationary;
affixed to the truss suspension structure; and
positioned proximate to a first distal corner node or a second distal corner node.

5. The trailer vehicle apparatus of claim 4, wherein a distance between the first vertical beam and the second vertical beam forms the strut channel.

6. The trailer vehicle apparatus of claim 5, wherein each of the plurality of truss structures are positioned within a wall of the trailer body.

7. The trailer vehicle apparatus of claim 6, further comprising
a pin fastener;
wherein
each strut structure comprises a first pin orifice positioned distal to the axle and traverses a width of the strut structure;
a wall of the trailer body is positioned adjacent to one of the strut structures;
the wall comprises a second pin orifice; and
the pin fastener is positioned through the first pin orifice and the second pin orifice and thereby locks the axle in an extended position when the trailer vehicle is in the mobile state.

8. The trailer vehicle apparatus of claim 7, further comprising:
a hitch component; and
wherein,
the hitch component is affixed proximate to the distal end of the second platform.

9. The trailer vehicle apparatus of claim 8, wherein
the hitch component comprises
a hitch base;
a hitch coupler; and
wherein
the hitch base is affixed to a bottom surface of the second platform; and
the hitch coupler is rotatably mounted to the hitch base.
